(19) United States
(12) Patent Application Publication
(10) Pub. No.: US 2009/0037544 A1
(43) Pub. Date: Feb. 5, 2009

(54) METHOD TO PROVIDE ASSISTANT ROLE IN INSTANT MESSAGE SOFTWARE

(75) Inventors: Lei Wang, Beijing (CN); Ying Xu, Beijing (CN)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/180,361

(22) Filed: Jul. 25, 2008

(30) Foreign Application Priority Data
Jul. 30, 2007 (CN) 200710139734.8

(51) Int. Cl. G06F 15/16

(52) U.S. Cl. 709/206

(57) ABSTRACT

The present invention provides a method for managing additional functions in an instant messaging system, a method for providing an additional function to an instant messaging system, an instant messaging system and IM client therein employing the methods. The instant messaging system enables a plurality of users to instantly message with each other through a network. The method for managing additional functions comprises: at a client of the instant messaging system, invoking a program for one of the additional functions in a session by way of interaction with a contact, wherein the additional function is recorded in local contact list of the client as the contact. The present invention enables a user to add a UI component corresponding to a needed additional function in the dialog of current chatting session only when necessary, thus reducing the complexity of the main UI.

### CROSS-REFERENCE TO RELATED APPLICATIONS

This application claims priority under 35 U.S.C. § 119(a) to Chinese Patent Application Serial Number 200710139734.8 filed Jul. 30, 2007 the entirety of which is incorporated herein by reference.

### TECHNICAL FIELD

The present invention relates to information processing technology, and in particular to a method for managing additional functions in an instant messaging system, a method for providing an additional function to an instant messaging system, an instant messaging system and instant messaging client therein employing the above methods.

### TECHNICAL BACKGROUND

Along with the popularization and development of the Internet, instant messaging has become important means for one to communicate with others. In many enterprises, besides file sharing, e-mails etc., the instant communication is applied widely in the situations of notifying, meeting, technical exchanging, project coordinating etc. due to the convenient, quick and efficient communication mode. In addition, many Internet users also tend to instantly communicating with friends through instant messaging.

The so-called instant messaging is a technology enabling a user to identify online users and exchange messages with them in real time through a network. A typical instant messaging system works as that: when someone in the buddy list of an instant messaging (IM) client logs on, the instant messaging system will send a message prompting this to the user of the IM client, who may then establish a session with the buddy to communicate with him through messages.

In general, an instant messaging system can transfer texts, files, voices or videos among two or more IM clients.

The infrastructure of a conventional instant messaging system is as shown in FIG. 1.

First, a user A inputs his user name and password to log on an IM server 11 of the instant messaging system. The IM server 11 verifies the identity of the user by reading a user database. If the user name and password are both correct, the IM server 11 will register IP address, version number and the used TCP/UDP port number of IM client software of the IM client 12 of the user A, and then return a prompt to the user A indicating the success of its logon. At the mean time, the status of the user A in the instant messaging system will become online presence.

Secondly, if a user B has already logged on and is online, then when the user A logs on successfully, the IM server 11 will notify the user B of the information related to the online of the user A in the case that the user A is in the buddy list of the user B stored on the IM server 11. The information includes the online status of the user A, the IP address and TCP port number of his IM client 12 and the like. When the information is received by the user B, a small window will be popped up on the desktop of his PC for prompting.

Thirdly, the IM server 11 feeds the buddy list and related information stored on the server by the user A back to the IM client 12 of the user A. The related information includes the online statuses of IM buddies in the buddy list, the IP addresses and TCP port numbers of their IM clients and the like. The IM client of the user A will display a list of the buddies and their online statuses after receiving the information.

Next, if the user A wishes to chat with his online buddy, user B, then he will directly send a chatting message to the user B based on the information such as the IP address, the TCP port number of the IM client 13 of the user B etc., received from the IM server 11. After receiving the message, the IM client 13 of the user B displays it on the screen. Then the user B can directly reply it by a message to the user A. Thus, instead that the instant messages of both the IM users A and B are relayed through the IM server 11, they will be transferred by a direct point-to-point communication through network, which is referred to as peer to peer communication.

At present, there exists much IM client software for providing instant messaging services, such as Sametime of IBM, MSN Messenger of Microsoft, Yahoo Messenger of Yahoo, GTalk of Google, QQ of Tencent, and so on.

In addition, at present, many software developers commit themselves to develop plug-ins providing additional functions to the existing IM client software in order that users will obtain more functions in instant communications. However, these additional functions are generally provided in the form of plug-in, and once the plug-in is installed, the main user interface of the IM client software will correspondingly be added in a button or menu for initiating the plug-in. Thus along with the continuous increase of additional functions, the user interface of the IM client software will inevitably become complicated. This will impact the use of the IM client software by IM user who requires a simple UI for quick communications.

Therefore, there is a need for a new mechanism for using and managing additional functions for the instant messaging system to resolve the problems existed in the prior art.

### SUMMARY OF THE INVENTION

The present invention is proposed in view of the above problem in the prior art, the object of which is to provide a method for managing additional functions in an instant messaging system, a method for providing an additional function to an instant messaging system, an instant messaging system and IM client therein employing the above methods, to regard additional functions as contacts in the instant messaging system, and enable the user to, like an ordinary contact, add and manage an additional function imitatively and invoke a certain additional function in a session like inviting an ordinary contact, thus obtaining great flexibility in the management and use of the additional functions.

According to one aspect of the present invention, there is provided a method for managing additional functions in an instant messaging system which enables a plurality of users to instantly message with each other through a network, comprising: at a client of the instant messaging system, invoking a program for one of the additional functions in a session by way of interaction with a contact, wherein the additional function is recorded in local contact list of the client as the contact.

According to another aspect of the present invention, there is provided a method for providing an additional function to an instant messaging system which enables a plurality of users to instantly message with each other through a network, comprising: creating a plug-in for an additional function for the instant messaging system; extending an extension point for creating a contact object and an extension point for enabling participation into a session provided by the instant messaging system in the plug-in; setting interfaces with the instant messaging system in the plug-in; and, implementing a specific additional function in the plug-in.

According to still another aspect of the present invention, there is provided an IM client in an instant messaging system, comprising: an IM client platform which adopts a framework allowing a program for an new additional function to be integrated into the IM client; a contact management service component for maintaining contact list of the IM client and creating a contact object for an additional function to add it into the contact list for management; and a basic chatting service component for enabling a contact object corresponding to an additional function in the contact list of the IM client to participate in a session.

According to a further aspect of the present invention, there is provided an instant messaging system which enables a plurality of users to instantly message with each other through a network, comprising: an IM server for registering, authenticating and managing contacts for the instant messaging system; and one or more IM clients in an instant messaging system described above, wherein at the one or more IM clients, a program for an additional function provided to the instant messaging system is invoked in a session by way of interaction with a contact, wherein the additional function is recorded in local contact list of the IM client as the contact.

### BRIEF DESCRIPTION OF THE DRAWINGS

It is believed that the features, advantages and purposes of the present invention will be better understood from the following description of the detailed implementation of the present invention read in conjunction with the accompanying drawings, in which:

FIG. 1 is a schematic diagram of the infrastructure of a conventional instant messaging system;

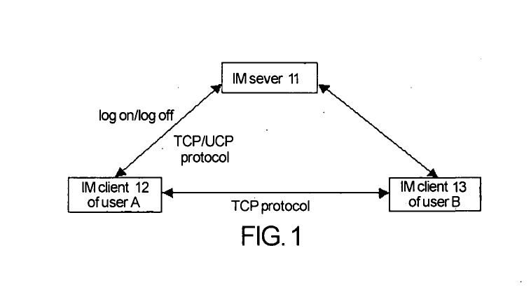

FIG. 2 is a schematic diagram of the infrastructure of an instant messaging system according to an embodiment of the present invention;

FIG. 3 is a schematic diagram of the framework of an IM client according to an embodiment of the present invention;

FIG. 4 is a flowchart of a method for adding an assistant into contact list of an IM client according to an embodiment of the present invention;

FIG. 5 is a flowchart of a method for deleting an assistant from contact list of an IM client according to an embodiment of the present invention;

FIG. 6 is a flowchart of a method for inviting an assistant into a chatting session at an IM client according to an embodiment of the present invention;

FIG. 7 is a flowchart for managing additional functions in an instant messaging system according to an embodiment of the present invention;

FIG. 8 is a flowchart of a method for providing an additional function to an instant messaging system according to an embodiment of the present invention;

FIG. 9 is a schematic diagram of the association between an assistant and the contact management service component as well as basic chatting service component in the present invention;

FIGS. 10(a)-10(d) showing a specific example of the process of adding an assistant into a contact list of an IM client according to an embodiment of the present invention; and

FIGS. 11(a)-11(c) showing a specific example of a process of inviting an assistant into a chatting session at an IM client according to an embodiment of the present invention.

### DETAILED DESCRIPTION OF THE INVENTION

Next, a detailed description of the preferred embodiments of the present invention will be given with reference to the drawings. First, the instant messaging system of the present invention will be described.

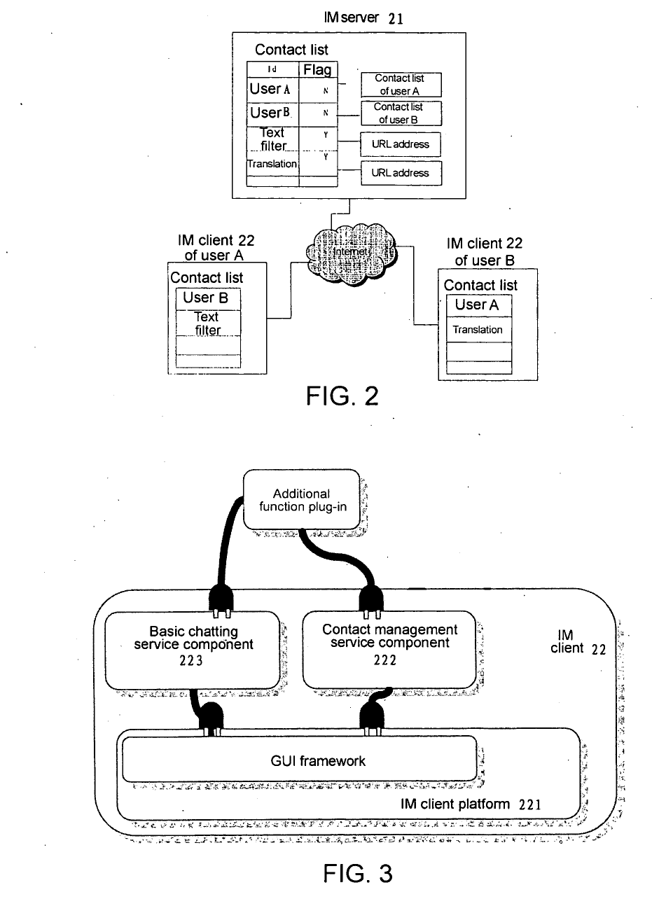

FIG. 2 is a schematic diagram of the infrastructure of an instant messaging system according to an embodiment of the present invention. As shown in FIG. 2, the instant messaging system of the present embodiment comprises IM server 21 and a plurality of IM clients such as IM client 22 of a user A and IM client 22 of a user B, and so on.

The IM server 21 manages registrations, logons and authentications by users in the instant messaging system, and manages registration information of users. Specifically, the user A inputs his user name and password to log on the IM server 21 of the instant messaging system. The IM server 21 verifies the identity of the user by reading a user database. If the user name and password are both correct, the IM server 21 will register IP address, version number and the used TCP/UDP port number of IM client software of the IM client 22 of the user A, and then return a prompt to the user A indicating the success of its logon. At the mean time, the status of the user A in the instant messaging system will become online presence.

Secondly, if the user B has already logged on and is online, then when the user A logs on successfully, the IM server 21 will notify the user B of the information related to the online of the user A in the case that the user A is in the buddy list of the user B stored on the IM server 21. The information includes the online status of the user A, the IP address and TCP port number of his IM client 22 and the like. When the information is received by the user B, a small window will be popped up on the desktop of his PC for prompting.

Thirdly, the IM server 21 feeds the buddy list and related information stored on the server by the user A back to the IM client 22 of the user A. The related information includes the online statuses of IM buddies (for example, the user B) in the buddy list, the IP addresses and TCP port numbers of their IM clients and the like. The IM client 22 of the user A will display the buddy list and the online statuses of the buddies in the buddy list after receiving the information.

Next, if the user A wishes to chat with his online buddy, user B, then he will directly send a chatting message to the user B based on the information such as the IP address, the TCP port number of the IM client 22 of the user B etc., received from the IM server 21. After receiving the message, the IM client 22 of the user B displays it on the screen. Then the user B can directly reply it by a message to the user A.

The above is the same as the conventional instant messaging system.

The instant messaging system of the present embodiment differs from the conventional instant messaging system in that, as shown in FIG. 2, the instant messaging system of the present embodiment registers an additional function plug-in provided by a software developer as a contact into a contact list of the IM server 21, and indicates it is a plug-in for providing the additional function but not a ordinary contact with a corresponding mark, for the selection and use of users.

Moreover, as shown in FIG. 2, in the present embodiment, in the contact list of the IM server 21, differing from an ordinary contact, for various additional function plug-ins, what are stored corresponding to their contact object IDs are the URL addresses of the additional function plug-ins.

Thus, the user such as user A, B etc. in the instant messaging system can search out the additional function plug-ins that can be provided by the system from the contact list of the IM server 21 like searching for an ordinary contact, select a certain additional function plug-in searched out like selecting an ordinary contact, and add it into his local IM client 22. As the mean time, the additional function plug-in will be downloaded to the IM client 22 automatically.

At the IM client side 22, the additional function plug-in is automatically installed, and a contact object is created for it and added into the local contact list. Thus at the IM client side 22, the additional function plug-in can be managed like an ordinary contact, and the user can use it by way of interaction with a contact in a session.

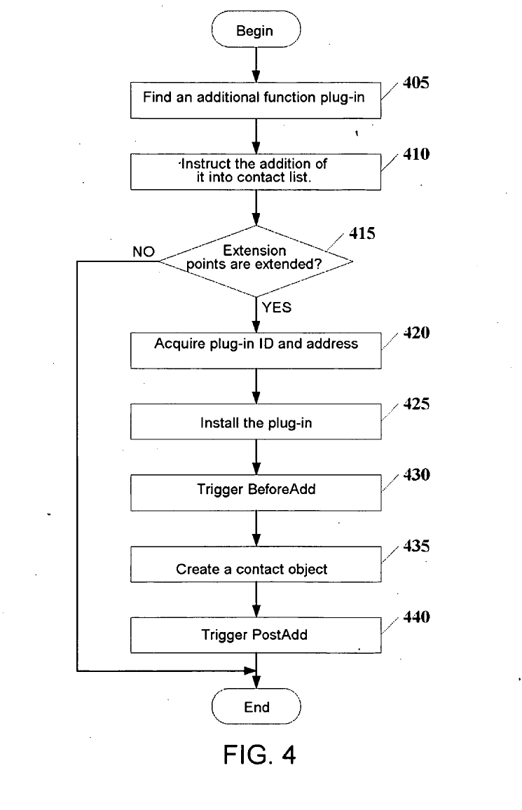

The IM client 22 will be further described in detail later in conjunction with FIG. 3.

It should be noted that, although in the above instant messaging system in FIG. 2, the additional function plug-ins first are registered into a contact list of the IM server 21, and then users search the additional function plug-ins from the contact list, the present invention is not limited to this. Since the core concept of the present invention is to add, manage or invoke additional function plug-ins as contacts at an IM client, as long as the inventive concept of the present invention is conformed to, the means for acquiring an additional function plug-in can be any. For example, it may be that the user of the IM client obtains an additional function plug-in directly from a software vendor and store it into local storage, instead of obtaining from the IM server 21.

In addition, it also needs to be noted that in the following description of the present specification, a contact object corresponding to an additional function plug-in in the contact list of the IM server 21 or a contact object corresponding to an additional function plug-in in the contact list of the IM client 22 is referred to as an assistant.

Next, the IM client 22 in the instant messaging system of FIG. 2 will be described in detail in conjunction with FIG. 3. FIG. 3 is a schematic diagram of the framework of an IM client according to an embodiment of the present invention. As shown in FIG. 3, the IM client of the embodiment at least comprises the following parts: IM client platform 221, contact management service component 222 and basic chatting service component 223.

The IM client platform 221 adopts a framework that allows new functions to be integrated into the IM client 22 easily and is able to provide good extensibility.

The contact management service component 222 manages the lifecycle of each contact in the IM client 22. Specifically, the contact management service component 222 provides functions such as importing a contact, creating a new contact, removing an existed contact, modifying the properties of an existed contact and so on. The so-called contact is a concept meaning contact objects to which the user of the IM client 22 can instantly communicate and assistants that can participate in a instant communication. In addition, in order to support extensibility, the contact management service component 222 further provides extension points for other components to extend.

The basic chatting service component 223 provides basic chatting functions for the user of the IM client 22. In addition, in order to support extensibility, the basic chatting service component 223 also provides extension points for other components to extend.

Next, the above parts will be described in detail, respectively.

### IM Client Platform

In order to realize the concept of the present invention, the IM client platform 221 should be a framework allowing new functions to be integrated into the IM client. Thus an IM plug-in for providing a new additional function, developed by a user, a developer or other independent software vendor can be integrated into the IM client 22 easily. In addition, a flexible framework of the IM client platform should also enable plug-ins to collaborate with each other.

As a preferred embodiment of the present invention, Eclipse framework is used to construct the IM client platform 221. However the present invention is not limited to this. In other embodiments, other frameworks that allow the integration of new functions can also be adopted to construct the IM client platform.

Eclipse is well known for its plug-in framework. The Eclipse platform is structured around the concept of plug-ins. The so-called plug-in is bundles of code and/or data capable of providing some new additional function. In addition, a plug-in connects with a universe of other plug-ins to form a running application. Further, it can be considered that each subsystem in the IM client platform 221 is itself structured by a set of plug-ins implementing different functions.

In addition, the Eclipse platform uses a mechanism of extensions and extension points to enable plug-ins to collaborate with each other, and enable all plug-ins to integrate as a whole application. If electrical outlets are used as a metaphor, then the outlet, or socket is the extension point, and the plug or light bulb connected to the outlet or socket is the extension. Further, when a plug-in wants to allow other plug-ins to extend or customize portions of its functionality, it needs to declare (provide) an extension point. Moreover, the extension point needs to declare a contract, typically a combination of XML markup and Java interfaces that corresponding extensions must conform to. Accordingly, plug-ins that wants to connect to that extension point must implement that contract in their extensions.

In the present embodiment, it is feasible to implement the IM client platform 221 by using the Eclipse's plug-in framework. For example, Lotus Sametime 7.5 of IBM is implemented based on the Eclipse's plug-in framework.

In addition, in the present embodiment, the runtime core of the IM client platform 221 adopting the Eclipse's plug-in framework is implemented as a runtime engine that can start a platform base and dynamically discover and run plug-ins.

In addition, the IM client platform 221 further maintains a registry of installed plug-ins and the functions they provide.

Contact Management Service Component

The contact management service component 222 manages the contacts of the user of the IM client 22. As mentioned above, it provides functions such as importing a contact, creating a new contact, removing an existed contact, modifying the properties of an existed contact and so on. The so-called contact is a concept meaning contact objects with to which the user of the IM client 22 can instantly communicate and assistants that can participate in a instant communication.

Specifically, for ordinary contacts, when the user of the IM client 22 logs on the IM server 21 and obtains his own contact list from the IM server 21, the contact management service component 222 creates a contact object for each ordinary contact in the contact list; and in the case that the user of the IM client 22 has logged on, when he adds an ordinary contact to his local contact list, the contact management service component 222 creates a contact object for the new added ordinary contact.

In addition, as described above, in the present invention, an additional function plug-in is regarded as a contact, i.e., an additional function plug-in can be registered with the contact list of the IM server 21 as a contact or added to the contact list of the IM client 22 as a contact, and in the present invention, such a contact object corresponding to an additional function plug-in is referred to as an assistant.

Thus in this case, when the user obtains his own contact list from the IM server 21 during logon, the contact management service component 222 further creates a contact object for each assistant in the contact list; and in the case that the user of the IM client 22 has logged on, when he adds an assistant to his local contact list, the contact management service component 222 also creates a contact object for the new added assistant.

For this, in terms of the contact management service component 222, the following specific implementation is needed.

Specifically, in order to support extensibility, the contact management service component 222 provides extension points for other components to extend. In this embodiment, for example, the extension point com.ibm.smartIM.contact is one provided by the contact management service component 222 for that other components can be identified as contacts to be created contact objects.

Thus as shown in FIG. 3, if an additional function plug-in is wished to be added to the IM client 22 and managed by the contact management service component 222 in the manner of a contact (as an assistant), it is need to extend the extension point com.ibm.smartIM.contact in its code implementation. In addition, the plug-in further needs to provide some information for creating a contact object, such as assistant ID, the ID and address of the additional function plug-in, contact ID and icon and so on. In addition, it should be noted that since the concepts of extension and extension point as well as the specific implementation thereof are common knowledge in the art and the present invention have no special limitation on this aspect, the further detailed description about them will be not given here.

Thus, for an additional function plug-in, in the case of recognizing it has extended the extension point com.ibm.smartIM.contact, the contact management service component 222 will create a contact object for it to manage it as a contact.

Specifically, for an assistant already existed in the local contact list obtained from the IM client platform 221 when the user logs on, as well as an assistant selected to add from the contact list of the IM client platform 221 or added directly at the local etc., the contact management service component 222 needs to determine whether its corresponding plug-in extended the extension point com.ibm.smartIM.contact. And in case of determining the plug-in extended the extension point, the contact management service component 222 creates a contact object for it based on the information provided by the plug-in as above, and adds the contact object into the local contact list of the IM client 22, so that the plug-in will be a so-called assistant in the contact list. It should be noted that in the process of newly adding an assistant, the plug-in corresponding to the assistant is automatically installed on the IM client 22. Further, the contact management service component 222 associates the ID (address) of the plug-in with the ID of the assistant, so that the assistant will be a UI invoking the additional function plug-in.

In addition, when the IM client platform 221 starts, the contact management service component 222 further needs to discover all additional function plug-ins which are stored locally in the IM client 22 and have extended the extension point com.ibm.smartIM.contact. Further, in the case that such additional function plug-ins are found out, the contact management service component 222 obtains information for creating contact objects from them, respectively so as to create contact objects for them, and add the contact objects into the local contact list of the IM client 22, so that these plug-ins will be so-called assistants in the local contact list.

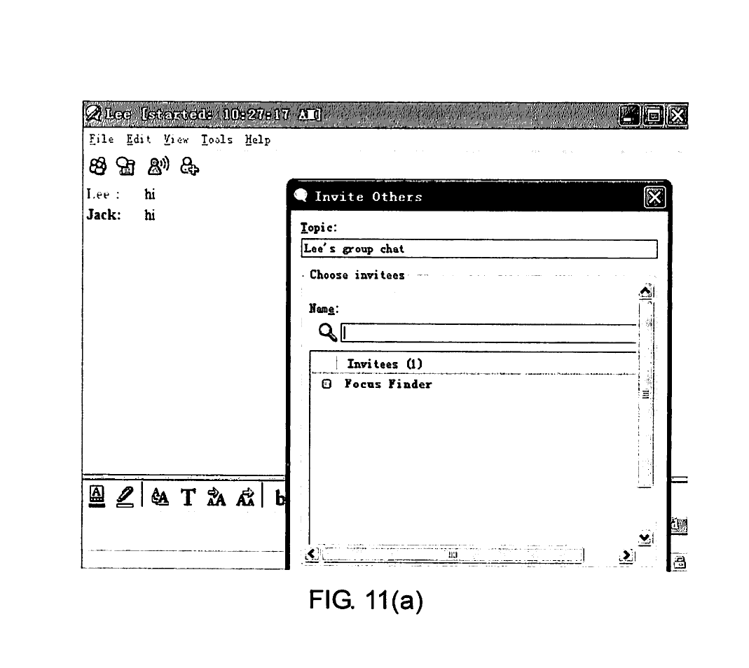

In order to implement the above functions such as adding, removing etc. of assistants, in the contact management service component 222, it is need to define events to be triggered when such action as adding or removing an assistant is performed. For example, events BeforeAdd, PostAdd are used for implementing the action of adding an assistant, and events BeforeDelete, PostDelete are used for implementing the action of removing an assistant. Moreover, as shown in FIG. 9, these events are packaged in an interface, for example IcontactManageable, provided by the contact management service component 222 for additional function plug-ins.

The definitions of the events are provided as follows.

BeforeAdd: an event that will be triggered when the user starts to add an assistant to the local contact list;

PostAdd: an event that will be triggered when the user finishes adding an assistant;

BeforeDelete: an event that will be triggered when the user starts to delete an assistant from the local contact list; and

PostDelete: an event that will be triggered when the user finishes deleting an assistant.

Accordingly, in addition to extending the extension point com.ibm.smartIM.contact as described above, the additional function plug-in, which is wished to be managed as an assistant, is further needed to implement the interface with the contact management service component 222, for example the above mentioned interface IcontactManageable, and optionally implement in the interface the methods corresponding to the above events in the interface of the contact management service component 222, for example BeforeAdd( ), PostAdd( ), BeforeDelete( ), PostDelete( ) and so on. Thus, when the contact management service component 222 triggers one of the events with respect to this plug-in, the corresponding method in this plug-in can be called through the interface, thus corresponding action such as assistant adding and deleting can be implemented by combining the contact management service component 222 with the plug-in. See FIGS. 3 and 9.

In addition, based on the event defined as above, the method for adding an assistant into the contact list of the IM client 22 and the method for deleting an assistant from the contact list of the IM client 22 will be described in detail below.

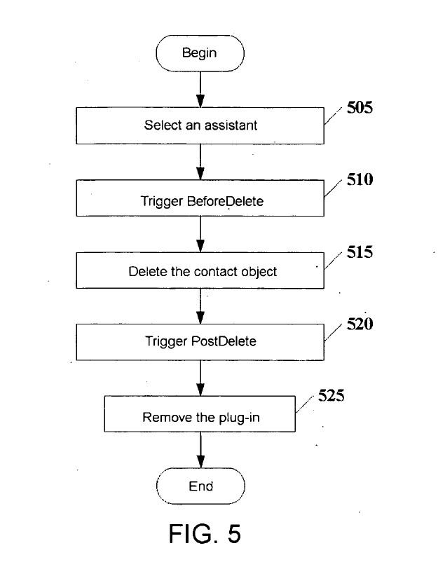

First, FIG. 4 is a flowchart of a method for adding an assistant into contact list of an IM client according to an embodiment of the present invention. As shown in FIG. 4, first, at step 405, user finds a plug-in that can implement the additional function he needs. The plug-in may be one searched out from the contact list of the IM server 21 by the user and stored at a certain URL address, or may be one obtained directly from a software vendor by the user and stored in the local storage of the IM client. In case that the additional function plug-in is searched out from the contact list of the IM server 21, as described above, the address of the plug-in is correspondingly stored in the contact list of the IM server 21, thus the plug-in can be obtained according to the address.

Next at step 410, the user instructs the addition of the plug-in into the local contact list of his IM client.

At step 415, it is determined whether an extension point com.ibm.smartIM.contact is extended in the plug-in. If so, the process proceeds to step 420, otherwise the process ends.

At step 420, such information as the ID, address etc. of the plug-in is acquired.

At step 425, the plug-in is installed on the IM client of the user based on such information as the ID, address etc. of the plug-in.

At step 430, the plug-in is activated and the event BeforeAdd is triggered, thus the method BeforeAdd( ) in the plug-in is called.

At step 435, a contact object is created for the plug-in, and is added into the contact list of the IM client. Specifically, at this step, the contact object is created for the plug-in based on such information as the assistant ID, the contact ID and the icon provided in the plug-in, and is added into the contact list of the IM client, and the contact list is updated, thus the plug-in will be a so-called assistant recorded in the contact list.

At step 440, the event PostAdd is triggered, thus the method PostAdd( ) in the plug-in is called. And the process ends.

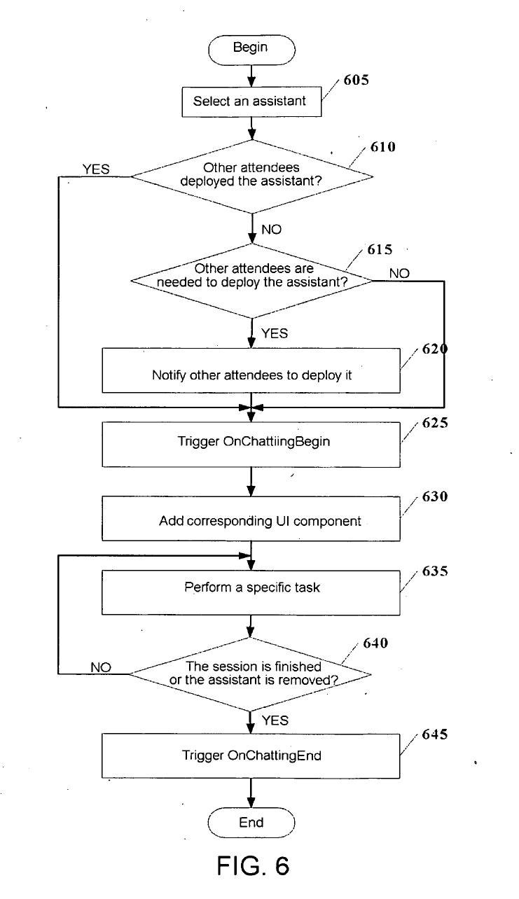

FIG. 5 is a flowchart of a method for deleting an assistant from contact list of an IM client according to an embodiment of the present invention. As shown in FIG. 5, at step 505, an assistant to be deleted from the contact list of the IM client is selected.

At step 510, the plug-in corresponding to the assistant is activated, the event BeforeDelete is triggered, thus the method BeforeDelete( ) in the plug-in is called.

At step 515, the contact object corresponding to the assistant is deleted from the contact list of the IM client, and the contact list is updated.

At step 520, the event PostDelete is triggered, and thus the method PostDelete( ) in the plug-in is called.

At step 525, the plug-in corresponding to the assistant is removed from the IM client, and the process ends.

Basic Chatting Service Component

The basic chatting service component 223 is used for providing basic chatting functions to the user of the IM client 22.

Specifically, the basic chatting service component 223 supports some standard protocol such as SIP, and can support different ways of chatting, such as text, audio, video and so on. Further, the basic chatting service component 223 provides some chatting graphic user interfaces and several dialogs for the user to instantly communicate with buddies or to personalize configuration related to instant communication on the IM client 22. The above is the same as that of the conventional basic chatting service component.

In addition, as mentioned above, in order to support extensibility, the basic chatting service component 223 provides extension points for other components to extend.

In this embodiment, for example, the extension point com.ibm.smartIM.chat is one provided by the basic chatting service component 223 for that an additional function plug-in corresponding to an assistant in the contact list can participate in a session.

Thus, if an assistant in the contact list of the IM client is wished to participate in a session, then the additional function plug-in corresponding to the assistant is further needed to extend the extension point com.ibm.smartIM.chat in its code implementation.

In addition, in order to enable an assistant to participate in a chat session, in the basic chatting service component 223, it is need to further define events to be triggered with respect to an assistant participating a session when user performs a certain action in the session. Moreover as shown in FIG. 9, these events are packaged in an interface, for example Ichatable, provided by the basic chatting service component 223 for additional function plug-ins corresponding to assistants.

The definitions of the events are provided as follows.

OnChattingBegin: an event that will be triggered when the user invites an assistant into a chatting session;

OnChattingEnd: an event that will be triggered when the user removes an assistant from a chatting session;

OnAttendeeJoin: an event that will be triggered when a new attendee participates in a chatting session;

OnAttendeeLeave: an event that will be triggered when an attendee leaves a chatting session;

OnTextMessageIn: an event that will be triggered when the user receives a message from others in a chatting session;

OnTextMessageOut: an event that will be triggered when the user sends a message to others in a chatting session;

OnFileSendBegin: an event that will be triggered when the user begins to transfer a file to the other in a chatting session;

OnFileSendFinish: an event that will be triggered when the user completes the transfer of the file;

OnFileReceiveBegin: an event that will be triggered when the user begins to receive a file from the other in a chatting session;

OnFileReceiveFinish: an event that will be triggered when the user completes the receiving of the file;

OnVoiceBegin: an event that will be triggered when the user starts the voice chatting;

OnVoiceEnd: an event that will be triggered when the user ends the voice chatting;

OnVideoBegin: an event that will be triggered when the user starts the video chatting; and

OnVideoEnd: an event that will be triggered when the user ends the video chatting.

Accordingly, in addition to extending the extension point com.ibm.smartIM.chat as described above, the additional function plug-in, which is wished to participate in a session, is further needed to implement the interface with the basic chatting service component 223, for example the above mentioned interface Ichatable, and optionally implement in the interface the methods corresponding to the above events in the interface of the basic chatting service component 223. Accordingly, when the basic chatting service component 223 triggers one of the events therein, the corresponding method in the plug-in can be called through this interface, thus the corresponding actions can be implemented in the chatting session by combining the basic chatting service component 223 with the plug-in. See FIGS. 3 and 9.

In addition, it should be noted that, in a practical implementation, a plug-in extending the extension point com.ibm.smartIM.chat may only implement a part of the above methods in its interface Ichatable to perform specific tasks, and for other methods, the basic chatting service component 223 will have default implementations.

For example, if an assistant is used to filter some text before a text message is sent out, then its corresponding plug-in may only implement the above method OnTextMessageOut( ), and perform a text filtering task. Thus when the user invites the assistant to participate into the current chatting session, its corresponding plug-in will be called to perform a text filtering task.

In addition, in order to enable assistants invited into a chatting session to participate in the session, the basic chatting service component 223 is further needed to provide corresponding plug-ins with APIs for getting information of the current chatting session, such as GetChatHistory, GetAttendeeInfo, etc.

Thus based on the methods defined as above, the method for inviting at the IM client 22 side an assistant into a chatting session will be described in detail below.

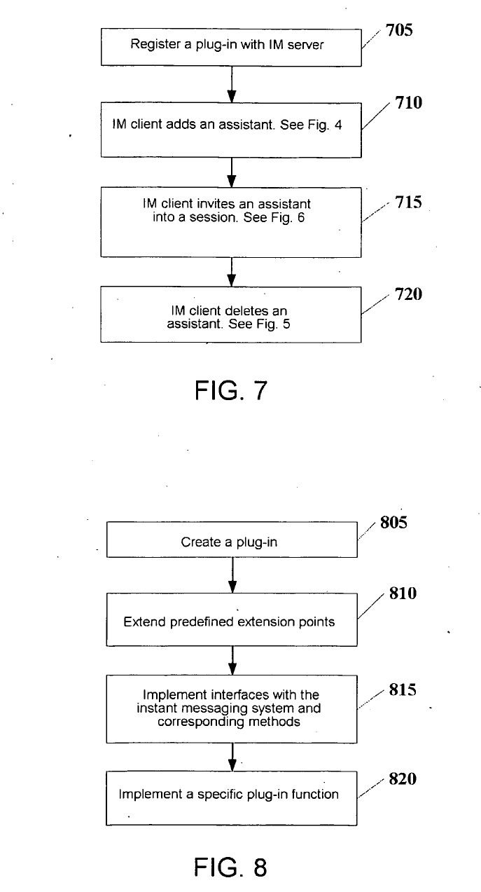

FIG. 6 is a flowchart of a method for inviting at an IM client an assistant into a chatting session according to an embodiment of the present invention. As shown in FIG. 6, first, at step 605, at an IM client, user selects an assistant in local contact list, and instructs to let it participate in a current chatting session of the user.

Next, at step 610, it is checked whether all other attendees in the current chatting session have deployed the assistant. If so, the process turns to step 625, otherwise the process proceeds to step 615.

At step 615, it is determined whether all other attendees in the current chatting session need to deploy the assistant. If so, the process proceeds to step 620, otherwise the process turns to step 625.

At step 620, the other attendees are notified to deploy the assistant by using the assistant's ID.

Next at step 625, at the IM client, based on such information as the plug-in ID and address, etc. recorded correspondingly to the assistant in the contact list, the additional function plug-in corresponding to the assistant is activated, and the event OnChattingBegin is triggered, thus the method OnChattingBegin( ) in the plug-in is further called.

At step 630, a UI component corresponding to the assistant is added into the dialog of the current chatting session dynamically.

In addition, at step 635, during the current chatting session, according to actions taken by the user, corresponding events are triggered, thus corresponding methods in the plug-in are further triggered to perform specific tasks. It should be noted that, since the plug-in is activated in the current chatting session, it can only be used in the current chatting session.

In addition, when it is determined at step 640 that the current chatting session is finished or the assistant is removed from the current chatting session, at step 645, the event OnChattingEnd is triggered, and thus the method OnChattingEnd( ) in the plug-in is further called. Further, the process ends.

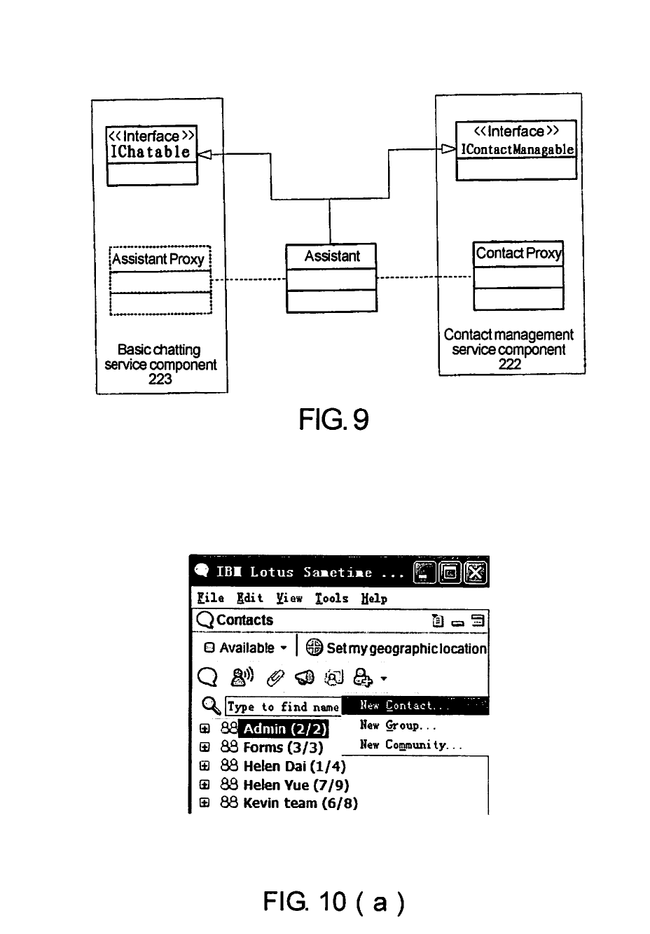

Based on the above description, the method for managing additional functions, used in the instant messaging system of the present embodiment is given below. FIG. 7 is a flowchart of a method for managing additional functions in an instant messaging system according to an embodiment of the present invention.

First, at an optional step 705, a software developer registers a plug-in providing an additional function with the contact list of the IM server 21. Specifically, in the contact list of the IM server, such information as the address of the plug-in is recorded correspondingly to the assistant name provided by the plug-in.

Next, at step 710, a user adds an assistant into contact list of his IM client. The plug-in implementing the function of the assistant may either be searched out from the contact list of the IM server 21 by the user, or be obtained directly from a software vendor and stored in the local storage of the IM client by the user. For the details of the step, refer specifically to the method for adding an assistant into contact list of an IM client, described in conjunction with FIG. 4.

Next at an optional step 715, the user invites at his IM client an assistant to a current chatting session. For the details of the step, refer specifically to the method for inviting at an IM client an assistant into a chatting session, described in conjunction with FIG. 6.

At an optional step 720, the user deletes an assistant from the contact list of his IM client. For the details of the step, refer specifically to the method for deleting an assistant from contact list of an IM client, described in conjunction with FIG. 5.

The above is a detailed description of the preferred embodiments of the instant messaging system and the method for managing additional functions in the instant messaging system of the present invention. In the present invention, by managing plug-ins providing additional functions as assistants in contact list, user can activate a corresponding assistant in the contact list only when its corresponding additional function is needed in a current chatting session, so that the UI component of the plug-in appears only in the dialog of the current chatting session and can be used only in the current chatting session. Therefore, the requirement for conciseness of the main user interface of an IM client can be satisfied, and the complexity of the main user interface is greatly decreased, thus the limited display space can be saved.

In addition to the above detailed description of the present invention, a precondition ensuring that the present invention can be implemented, i.e., corresponding works needed to be done at the side of providers of the additional functions, should be further described.

That is, for a provider, in order to enable his additional function plug-in to be managed and invoked as an assistant in contact list of an IM client, he needs to implement the plug-in as one that can be installed, activated, removed at the IM client and extends corresponding extension points provided by the client. Specifically, the plug-in providing an additional function is needed to extend a specific extension point provided by the contact management service component of the IM client, for example the above com.ibm.smartIM.contact. Further, if the plug-in is wished to further participate in a chatting session as an assistant, then it is needed to extend a specific extension point provided by the basic chatting service component, for example the above com.ibm.smartIM.chat. Thus, only when the user invites the assistant corresponding to the plug-in into his current chatting session, can the plug-in provide the specific additional function to the chatting session.

Next, the process that a software vendor provides an additional function to an instant messaging system in the context of the present invention will be described in detail in conjunction with a drawing.

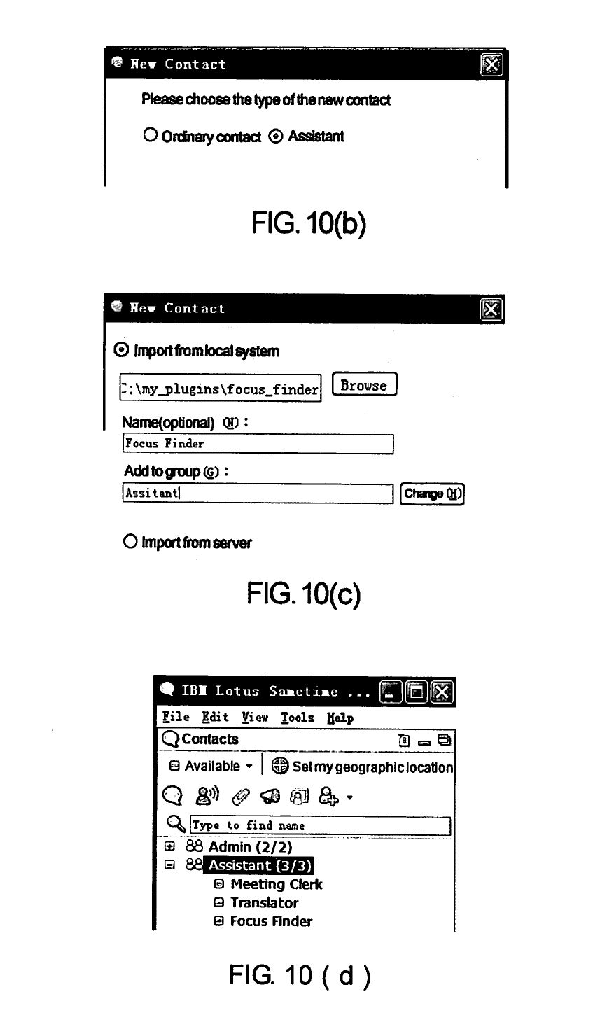

FIG. 8 is a flowchart of a method for providing an additional function to an instant messaging system according to an embodiment of the present invention. As shown in FIG. 8, first at step 805, a plug-in is created.

At step 810, in the plug-in, specific extension points provided by the instant messaging system, for example the extension point com.ibm.smartIM.contact provided by the contact management service component and the extension point com.ibm.smartIM.chat provided by the basic chatting service component, mentioned above, are extended. In addition, in extending the extension point provided by the contact management service component, such information as the corresponding contact ID, icon and assistant name further needs to be set in the plug-in.

Next at step 815, an assistant class is set in the plug-in to implement interfaces with the instant messaging system, for example, the interface IContactManageable with the contact management service component and the interface Ichatable with the basic chatting service component, mentioned above. In these interfaces, corresponding methods are packaged respectively. These methods are set in order to enable the plug-in to be managed by the contact management service component and invoked in a session by the basic chatting service component as an assistant in the contact list of the IM client. By taking a plug-in providing an English to Chinese text translation function as an example, it as least needs to implement such methods as OnChattingBegin( ), OnChattingEnd( ), OnTextMessageIn( ), OnTextMessageOut( ) and etc. in the interface IChatable with the basic chatting service component, and implement such methods as BeforeAdd( ), PostAdd( ), BeforeDelete( ), PostDelete( ) and etc. in the interface IContactManageable with the contact management service component, which has been introduced above.

Next, at step 820, the specific function of the plug-in is implemented. Still by taking the plug-in providing text translation function from English to Chinese as an example, at the step, it needs to implement a specific text translation function of the plug-in from English to Chinese.

The above is a detailed description of the method for providing an additional function to an instant messaging system of the present embodiment. It should be noted that the description of the steps and the execution sequence thereof provided in the present embodiment are only exemplary for illustration, instead of any limitation.

While the method for managing additional functions in an instant messaging system, the method for providing an additional function to an instant messaging system, the instant messaging system and the IM client therein employing the methods of the present invention have been described in detail in conjunction with some exemplary embodiments about plug-ins providing additional functions, the present invention is not limited to the case of plug-ins providing additional functions, instead the present invention is applicable for any form of program, for example ActiveX, asp and etc, that can provide an additional function to an IM client.

In the following, an assistant instance, Focus Finder, which can analyze the focus of session contents and index the session contents to facilitate user to find needed content of a session, will be provided. The main function of the assistant Focus Finder is to analyze session contents through preset keywords and perform a statistics on the keywords to find the most frequently used keywords in a session, and it further can index the session contents according to the keywords to facilitate user to quickly locate a certain talking based on keywords.

In the following, by taking the assistant Focus Finder as an example, it will be described in detail on how a user Xiao Wang adds the assistant into his IM client and invokes the assistant in a session.

Adding the Assistant

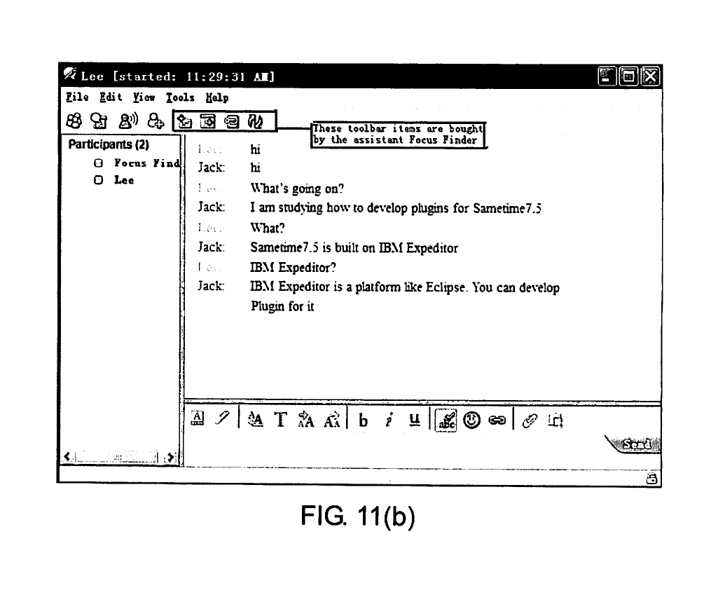

1. As shown in FIG. 10(a), like adding a contact, the New Contact menu for adding a new contact in the IM user interface is clicked;

2. As shown in FIG. 10(b), it is selected to import an assistant in the guide New Contact Wizard for adding a new contact;

3. As shown in FIG. 10(c), it is selected to import the assistant from C:\my_plugins\focus_finder.plugins of local system; and

4. As shown in FIG. 10(d), the assistant Focus Finder is successfully added into the local contact list of the IM client of the user Xiao Wang.

Invoking the Assistant

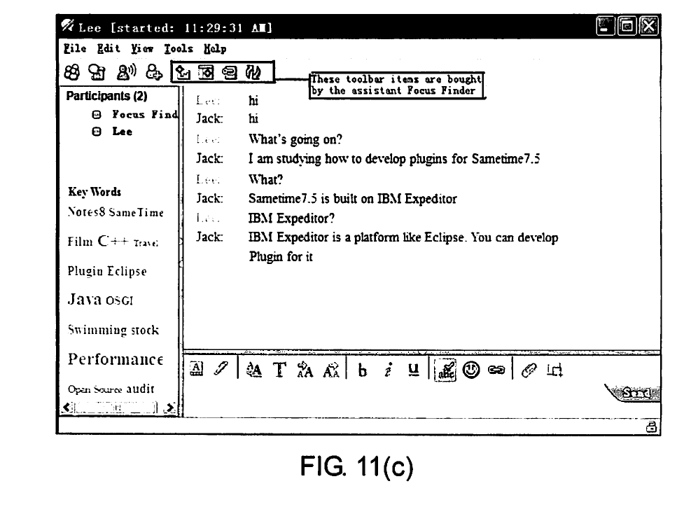

1. As shown in FIG. 11(a), the user Xiao Wang is chatting with a buddy Li Ke through instant messaging, and the user Xiao Wang is preparing to invite the assistant Focus Finder into the current session, just as inviting an ordinary contact, so as to process the session contents;

2. As shown in FIG. 11(b), when the assistant Focus Finder is added into the session, a corresponding UI element is added to the current session interface so that the user Xiao Wang can use the function provided by the assistant Focus Finder;

Further, during the session, the assistant Focus Finder automatically analyzes the contents of the session, increases the count values for occurred keywords, and automatically counts newly appeared terms in the session content as keywords; and

3. As shown in FIG. 11(c), if the user Xiao Wang wishes to check the occurrence frequencies of the keywords by far, then he can click the toolbar item [symbol] added by the assistant Focus Finder, then a keyword display view will be added into the dialog of the current session for user to see.

In addition, in practice, in addition to the assistant Focus Finder, various assistants providing respective functions also can be implemented, for example:

1) a translation assistant for translating session contents from one language into another one;

2) a meeting secretary for identifying useful contents in a session and making a meeting record according to the useful contents;

3) a content analysis assistant for analyzing session contents and finding the most frequently used words; and

4) a meeting schedule assistant for checking the calendar of each attendee in a session so as to arrange a suitable meeting time, and so on.

The above embodiments are not exhaustive, and those skilled in the art may make various variations and modifications within the spirit and scope of the present invention. Therefore, the present invention is not limited to these embodiments, the scope of which is only defined by appended claims.

1. A method for managing additional functions in an instant messaging system which enables a plurality of users to instantly message with each other through a network, comprising:
at a client of the instant messaging system, invoking a program for one of the additional functions in a session by way of interaction with a contact, wherein the additional function is recorded in local contact list of the client as the contact.

2. The method for managing additional functions in an instant messaging system according to claim 1, wherein the additional functions are registered in a contact list of a server of the instant messaging system as contacts so that clients can searched out the information of the additional functions by way of searching contacts.

3. The method for managing additional functions in an instant messaging system according to claim 2, wherein each record about one of the additional functions in the contact list of the server of the instant messaging system includes the ID and address of the additional function.

4. The method for managing additional functions in an instant messaging system according to claim 2, further comprising:
searching for the information of available additional functions from the contact list of the server;
selecting said additional function from the searching result;
installing the program for the additional function onto the client based on the record about the additional function in the contact list of the server; and
creating a contact object for the additional function at the client to add it into the local contact list of the client.

5. The method for managing additional functions in an instant messaging system according to claim 1, further comprising the steps of:
obtaining the program for the additional function locally at the client;
installing the program for the additional function onto the client; and
creating a contact object for the additional function at the client to add it into the local contact list of the client.

6. The method for managing additional functions in an instant messaging system according to claim 4, wherein the program for the additional function comprises an additional function plug-in; and at the client, in condition that extension points for creating a contact object, provided by the client, are extended in the additional function plug-in, a contact object is created for the additional function.

7. The method for managing additional functions in an instant messaging system according to claim 4, wherein the position information of the program for the additional function is recorded in the contact object for the additional function.

8. The method for managing additional functions in an instant messaging system according to claim 1, further comprising:
activating the contact object corresponding to the additional function from the local contact list in a user session of the client.

9. The method for managing additional functions in an instant messaging system according to claim 8, wherein the activating step further comprises:
selecting the contact object corresponding to the additional function in the local contact list of the client; and
invoking the program for the additional function based on the position information of the program for the additional function, recorded for the contact object in the local contact list.

10. The method for managing additional functions in an instant messaging system according to claim 9, wherein the activating step further comprises:
importing available UI components corresponding to the additional function appear in the interface of current session.

11. The method for managing additional functions in an instant messaging system according to claim 8, further comprising:
when the additional function is activated in the session of the client, pushing the additional function to other clients in the session by way of notification.

12. The method for managing additional functions in an instant messaging system according to claim 8, wherein after the additional function is activated in the session of the client, the additional function is available only in the session.

13. An IM client in an instant messaging system, comprising:
an IM client platform which adopts a framework allowing a program for an new additional function to be integrated into the IM client;
a contact management service component for maintaining contact list of the IM client and creating a contact object for an additional function to add it into the contact list for management; and
a basic chatting service component for enabling a contact object corresponding to an additional function in the contact list of the IM client to participate in a session.

14. The IM client in an instant messaging system according to claim 13, wherein the contact management service component comprises:
an unit for searching the information of available additional functions from contact list of a server;
an unit for installing a program for an additional function onto the IM client based on the record about the additional function in the contact list of the server; and
an unit for creating a contact object for the additional function at the IM client to add it into the local contact list of the IM client.

15. The IM client in an instant messaging system according to claim 13, wherein the IM client platform supports additional function programs in the form of plug-in; and
the program for the additional function comprises a additional function plug-in.

16. An instant messaging system which enables a plurality of users to instantly message with each other through a network, comprising:
an IM server for registering, authenticating and managing contacts for the instant messaging system; and
one or more IM clients in an instant messaging system,
wherein at the one or more IM clients, a program for an additional function provided to the instant messaging system is invoked in a session by way of interaction with a contact, wherein the additional function is recorded in local contact list of the IM client as the contact.
